(19) United States
(12) Patent Application Publication
(10) Pub. No.: US 2025/0388521 A1
(43) Pub. Date: Dec. 25, 2025

(54) CONTROLLED REACTION RATES OF THERMOCHEMICAL FLUIDS USING EMULSIONS

(71) Applicants: Saudi Arabian Oil Company, Dhahran (SA); King Fahd University of Petroleum & Minerals, Dhahran (SA)

(72) Inventors: Alade Olalekan Saheed, Dhahran (SA); Mohamed Mahmoud, Dhahran (SA); Dhafer Al-Shehri, Dhahran (SA); Ayman Raja Al-Nakhli, Dammam (SA)

(21) Appl. No.: 19/313,521

(22) Filed: Aug. 28, 2025

Related U.S. Application Data
(62) Division of application No. 17/664,149, filed on May 19, 2022.

(51) Int. Cl. C06B 47/14; B01F 23/41; C09K 8/536; C09K 8/58; C09K 23/38

(52) U.S. Cl. CPC C06B 47/145; B01F 23/4146; C09K 23/38; C09K 8/536; C09K 8/58

(57) ABSTRACT

Compositions containing a first reactant; an emulsion comprising a surfactant and silicon dioxide (SiO₂) nanoparticles; and a carrier fluid containing a second reactant and methods of making. When the first and second reactants react, they generate heat. At a first time, the emulsion surrounds the first reactant, and the carrier fluid with the second reactant surrounds the emulsion. At a second time, the emulsion surrounds a first portion of the first reactant; and a second portion of the first reactant surrounds the emulsion.

### CROSS-REFERENCE TO RELATED APPLICATIONS

This application is a divisional application of and claims the benefit of priority to U.S. application Ser. No. 17/664, 149, filed on May 19, 2022, the contents of which are hereby incorporated by reference.

### FIELD

The disclosure relates to compositions and methods for controlling the reaction rates of thermochemical fluids using emulsions.

### BACKGROUND

The reactants of a thermochemical fluid can generate heat and pressure (due to the generation of gas) upon their reaction. The heat can be used in various applications in the petroleum industry, such as condensate removal and flow assurance, cleaning of petroleum sludge, production enhancement including stimulation for improvement of rock petrophysical properties and removal of condensate banking, fracturing, and heavy oil/bitumen production.

### SUMMARY

The disclosure relates to compositions and methods for controlling the reaction rates of thermochemical fluids using emulsions. This can allow for the controlled generation of heat and/or pressure at a desired location and/or time. For example, the heat and/or pressure can be generated at a target location for use in pipeline cleaning and flow assurance, condensate removal, well stimulation, in-situ thermal enhanced recovery of heavy and extra-heavy oils (bitumen or tar), and fracturing. In certain embodiments, the heat and/or pressure can be generated in areas that are relatively difficult to reach. In some embodiments, the compositions and methods can reduce (e.g., prevent) the adsorption of a reactant in a thermochemical fluid due to rock-fluid interactions. In certain embodiments, the compositions and methods can be used in the absence of acidic activators and changes in pH. In some embodiments, the compositions and methods can offer relatively high heat transfer efficiency with relatively little greenhouse gas emission. In certain embodiments, the compositions and methods can be more energy efficient than other methods of heating.

In general, a composition according to the disclosure includes an emulsion that initially separates the reactants of the thermochemical fluid. Over time, one of the reactants is able to pass through the emulsion so that the reactants can react to generate heat and/or pressure. In some embodiments, the emulsion contains a surfactant and silicon dioxide (SiO₂) nanoparticles. Optionally, the emulsion can also contain a co-surfactant. In certain embodiments, the reactants and emulsion and contained within a carrier fluid, such as diesel. Without wishing to be bound by theory, it is believed that the SiO₂ nanoparticles may stabilize the emulsion.

In a first aspect, the disclosure provides a composition that includes: a first reactant; an emulsion including a surfactant and silicon dioxide (SiO₂) nanoparticles; and a carrier fluid including a second reactant. When the first and second reactants react, they generate heat. At a first time, the emulsion surrounds the first reactant, and the carrier fluid including the second reactant surrounds the emulsion. At a second time, the emulsion surrounds a first portion of the first reactant; and a second portion of the first reactant surrounds the emulsion.

In some embodiments, when the first and second reactants react, they generate a gas. The gas can be nitrogen (N₂).

In some embodiments, the composition is configured so that the gas has a foam stability of at least 25%.

In some embodiments, one of the following holds: a) the first reactant includes an ammonium ion and the second reactant includes a nitrite ion; and b) the second reactant includes an ammonium ion and the first reactant includes a nitrite ion.

In some embodiments, one of the following holds: a) the first reactant includes a member selected from ammonium chloride, ammonium bromide, ammonium nitrate, ammonium sulfate, ammonium carbonate, and ammonium hydroxide, and the second reactant includes a member selected from sodium nitrite and potassium nitrite; and b) the second reactant includes a member selected from ammonium chloride, ammonium bromide, ammonium nitrate, ammonium sulfate, ammonium carbonate, and ammonium hydroxide, and the first reactant includes a member is selected from sodium nitrite and potassium nitrite.

In some embodiments, the surfactant includes polyvinyl alcohol.

In some embodiments, the composition further includes a co-surfactant. The co-surfactant can be ethanol.

In some embodiments, the composition includes between 0.5 percent weight/volume (% wt./v.) and 2% wt./v. of SiO₂ nanoparticles.

In some embodiments, the emulsion has a diameter from 50 to 200 μm.

In some embodiments, the second time is at most 90 minutes after the first time, and the second portion is at least 1.5 times the first portion.

In some embodiments, the carrier fluid includes a member selected from the group consisting of diesel and a polymer-containing liquid.

In some embodiments: the surfactant includes polyvinyl alcohol; the composition includes between 0.5% wt./v and 2% wt./v. of SiO₂ nanoparticles; the emulsion further includes ethanol; the carrier fluid includes diesel; and one of the following holds: a) the first reactant includes a member selected from ammonium chloride, ammonium bromide, ammonium nitrate, ammonium sulfate, ammonium carbonate, and ammonium hydroxide, and the second reactant includes a member selected from sodium nitrite and potassium nitrite; and b) the second reactant includes a member selected from ammonium chloride, ammonium bromide, ammonium nitrate, ammonium sulfate, ammonium carbonate, and ammonium hydroxide, and the first reactant includes a member is selected from sodium nitrite and potassium nitrite.

In some embodiments, at least one of the following holds: a) the composition is configured so that a time period for a maximum achievable temperature due to the reaction between the first and second reactants is at least two minutes greater than a time period for a maximum achievable temperature due to the reaction between the first and second reactants in the absence of the emulsion; and b) the composition is configured so that, when the first and second reactants react, a temperature of 25° C. to 65° C. is maintained for at least 10 minutes.

In a second aspect, the disclosure provides a method that includes providing a composition, wherein the composition includes: a first reactant; an emulsion surrounding the first reactant, the emulsion including a surfactant and silicon dioxide (SiO₂) nanoparticles; and a carrier fluid including a second reactant, the carrier fluid including the second reactant surrounding the emulsion. The method also includes allowing a portion of the first reactant to diffuse through the emulsion so that the first and second reactants react to generate heat.

In some embodiments, the reaction of the first and second reactants generates a gas.

In some embodiments, one of the following holds: a) the first reactant includes an ammonium ion and the second reactant includes a nitrite ion; and b) the second reactant includes an ammonium ion and the first reactant includes a nitrite ion.

In some embodiments, the at least 60% of the first reactant diffuses through the emulsion within 90 minutes.

In a third aspect, the disclosure provides a method of forming an emulsified thermochemical reactant. The method includes: a) mixing a surfactant and a co-surfactant to form a first composition; b) adding a carrier fluid to the first composition and mixing to form a second composition; c) adding silicon dixoide (SiO₂) nanoparticles to the second composition and mixing to form a third composition; d) adding a first reactant to the third composition and mixing to form an emulsion surrounding the first reactant, the emulsion including the surfactant and the silica nanoparticles; and after d), e) adding a second reactant so that the second reactant surrounds the emulsion. When the first and second reactants react, they generate heat.

### BRIEF DESCRIPTION OF THE FIGURES

FIG 1a is a schematic illustration of a composition.

FIG. 1b is a schematic illustration of a composition.

FIG. 2 is a flow diagram for a method.

FIG. 3a is a photograph of emulsions at different mixing times.

FIG. 3b is a graph showing particle size distributions at different mixing times.

FIG. 4a is a photograph of emulsions at different mixing times.

FIG. 4b is a graph showing particle size distributions at different mixing times.

FIG. 5a is a photograph of emulsions at different mixing times.

FIG. 5b is a graph showing particle size distributions at different mixing times.

FIG. 6a is a graph showing concentrations of reactant released.

FIG. 6b is a photograph of samples.

FIG. 7a is a graph showing concentrations of reactant released.

FIG. 7b is a photograph of samples.

FIG. 8a is a graph showing concentrations of reactant released.

FIG. 8b is a photograph of samples.

FIG. 9 is a graph showing the differential release rate of the reactants.

FIG. 10 is a graph showing temperature change with time from the reactions.

FIG. 11 is a graph showing temperature change with time from the reactions.

FIG. 12 is a graph showing foam stability of the reactions.

### DETAILED DESCRIPTION

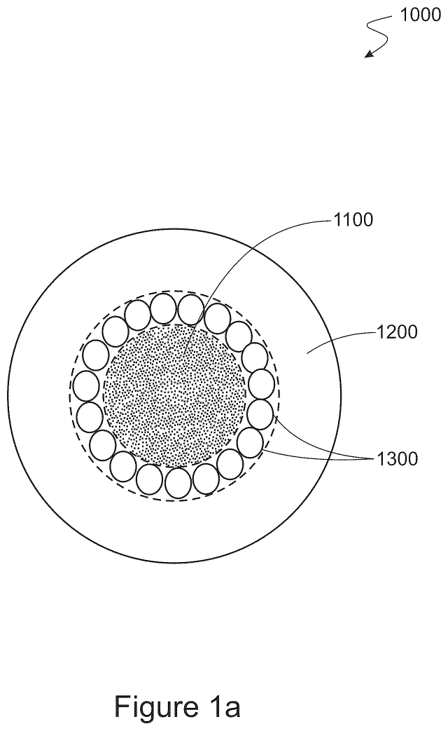

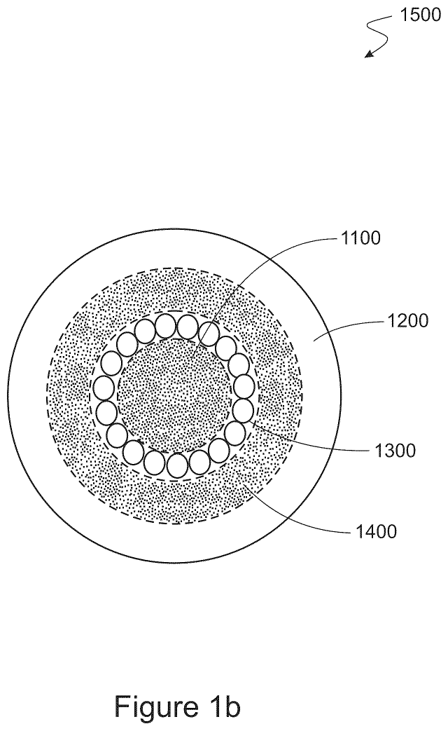

Figure la is a schematic illustration of a composition 1000 at a first time, and FIG. 1b is a schematic illustration of a composition 1500 at a later time.

In FIG 1a, the composition 1000 has a first liquid region 1100 that includes a carrier fluid and a first reactant of a thermochemical fluid. The composition 1000 also has a second liquid region 1200 that includes the carrier fluid and a second reactant of the thermochemical fluid. In addition, the composition 1000 includes an emulsion 1300 that separates the first liquid region 1100 from the second liquid region 1200. The emulsion 1300 reduces (e.g., prevents) interaction between the reactants of the thermochemical fluid.

In FIG. 1b, the composition 1500 includes the first liquid region 1100, the second liquid region 1200 and the emulsion 1300. However, unlike the composition 1000, the composition 1500 further includes a third liquid region 1400 containing the carrier fluid and the first reactant. In other words, FIG. 1b shows that with the passage of time some of the first reactant contained in the first liquid region 1100 passes through the emulsion 1300 to provide the third liquid region 1400. As a result, in the composition 1500 the first and second reactants are able to react to generate heat and/or pressure (e.g., due to the generation of a gas, such as nitrogen (N₂)).

In general, the reactants of the thermochemical fluid can be any appropriate reactants. In certain embodiments, the reactants of the thermochemical fluid include an ammonium ion (e.g., ammonium chloride, ammonium bromide, ammonium nitrate, ammonium sulfate, ammonium carbonate, ammonium hydroxide) and a nitrite ion (e.g., sodium nitrite, potassium nitrite). In such embodiments, in the initial composition 1000, the ammonium ion is in region 1100 and the nitrite ion is in the region 1200, or the nitrite ion is in region 1100 and the ammonium ion is in the region 1200. For example, in certain embodiments, in the initial composition 1000, ammonium chloride is in region 1100 and sodium nitrite is in the region 1200, or sodium nitrite is in region 1100 and ammonium chloride is in the region 1200.

Generally, the carrier fluid can be any appropriate carrier fluid. In certain embodiments, the carrier fluid is diesel. In certain embodiments, the carrier fluid is a polymer-containing liquid. Examples of polymers include polylysine, polyethyleneimine, chitosan, and dextran sulfate.

In general, the emulsion contains a surfactant and nanoparticles. Optionally, the emulsion can also contain a co-surfactant. Examples of nanoparticles include silicon dioxide (SiO₂) nanoparticles, zinc oxide (ZnO) nanoparticles, magnesium oxide (MgO) nanoparticles, and iron oxide (Fe₃O₄) nanoparticles. In some embodiments, the emulsion contains SiO₂ nanoparticles.

Generally, the emulsion can contain any appropriate surfactant. Examples of surfactants include polyvinyl alcohol, sodium-dodecyl-benzenesulfonate, ethoxylated alcohol, isopropyl alcohol, quaternary ammonia compounds, sorbitan esters (e.g. span surfactant (Span 20, 40, 60,65, 80, and 85)), and polysorbate surfactants (e.g. Tween 20, 40, 60, 65, 80, and 85). In some embodiments, the emulsion contains at least 1 (e.g., at least 5, at least 7) volume by volume percent (v/v %) surfactant and at most 15 (e.g., at most 10, at most 8) v/v % surfactant.

In certain embodiments, the emulsion contains at least 0.1 (e.g., at least 0.5, at least 0.75) weight by volume percent (wt/v %) SiO₂ nanoparticles and at most 2 (e.g., at most 1.5, at most 1) wt/v % SiO₂ nanoparticles. In some embodiments, the SiO₂ nanoparticles have a particle diameter of at least about 10 (e.g., at least about 12, at least about 15) nm and at most about 20 (e.g., at most about 18, at most about 15) nm.

In general, any appropriate co-surfactant can be used. Examples of co-surfactants include ethanol, butanol, hexanol and octanol. In some embodiments, the emulsion contains at least 2 (e.g., at least 3, at least 4) v/v % co-surfactant and at most 5 (e.g., at most 4, at most 3) v/v % co-surfactant.

In general, the emulsion can have a range of particle sizes. In certain embodiments, the emulsion can have a diameter of at least 22 (e.g. at least 30, at least 35) micrometers (μm) and at most 55 (e.g. at most 50, at most 44, at most 40, at most 38) μm.

In some embodiments, at least 60 (e.g. at least 70, at least 75) % and at most 100 (e.g. at most 90, at most 80) % of the reactant contained in region 1100 (FIG. 1a) passes through the emulsion within at least 10 (e.g. at least 20, at least 30) minutes and at most 120 (e.g. at most 90, at most 85, at most 80, at most 70, at most 60, at most 50, at most 40) minutes. Without wishing to be bound by theory, it is believed that the rate at which the reactant passes through the emulsion is at least partially determined by the concentration of SiO₂ nanoparticles in the emulsion. For example, it is believed that, in certain embodiments, the rate at which the reactant passes through the emulsion generally decreases with increasing concentration of SiO₂ nanoparticles.

In certain embodiments, the onset of peak temperature due to the reaction of the reactants can be delayed due to the presence of the emulsion by at least 1 (e.g. at least 2, at least 5, at least 10, at least 20) minutes and at most 60 (e.g. at most 50, at most 45, at most 40, at most 30, at most 20) minutes, relative to if the emulsion were not present in the composition. Without wishing to be bound by theory, it is believed that the onset of peak temperature is at least partially determined by the concentration of SiO₂ nanoparticles in the emulsion. For example, it is believed that, in some embodiments, the onset of peak temperature is generally increasingly delayed with increasing concentration of SiO₂ nanoparticles.

In some embodiments, the peak temperature due to the reaction of the reactants is at least 25 (e.g. at least 30, at least 40)° C. and at most 65 (e.g. at most 60, at most 55)° C. Without wishing to be bound by theory, it is believed that the peak temperature is at least partially determined by the concentration of SiO₂ nanoparticles in the emulsion. For example, it is believed that, in certain embodiments, the peak temperature generally decreases with increasing concentration of SiO₂ nanoparticles.

In some embodiments, an increase in temperature generated by a thermochemical reaction can be maintained for an extended period of time relative to if the emulsion were not present in the composition. In certain embodiments, a temperature of at least 25 (e.g. at least 30, at least 40)° C. and at most 65 (e.g. at most 60, at most 55)° C. can be maintained for a period of at least 10 (e.g. at least 20, at least 30) minutes and at most 120 (e.g. at most 110, at most 100, at most 90, at most 80, at most 70, at most 60, at most 50, at most 40) minutes. Without wishing to be bound by theory, it is believed that this time period is at least partially determined by the concentration of SiO₂ nanoparticles in the emulsion. For example, it is believed that, in some embodiments, the duration of the generation of temperature generally increases with increasing concentration of SiO₂ nanoparticles.

In some embodiments, foam stability from gas (e.g., N₂) generated by a thermochemical reaction can be increased relative to if the emulsion were not present in the composition. Without wishing to be bound by theory, it is believed that, in certain embodiments, this foam stability is at least partially determined by the concentration of SiO₂ nanoparticles in the emulsion and that the foam stability generally increases with increasing concentration of SiO₂ nanoparticles. In some embodiments, the gas (e.g., N₂) has a foam stability of at least 30 (e.g., at least 40, at least 50) v/v % and at most 90 (e.g., at most 80, at most 70) v/v % according to the test described below (see Example 5).

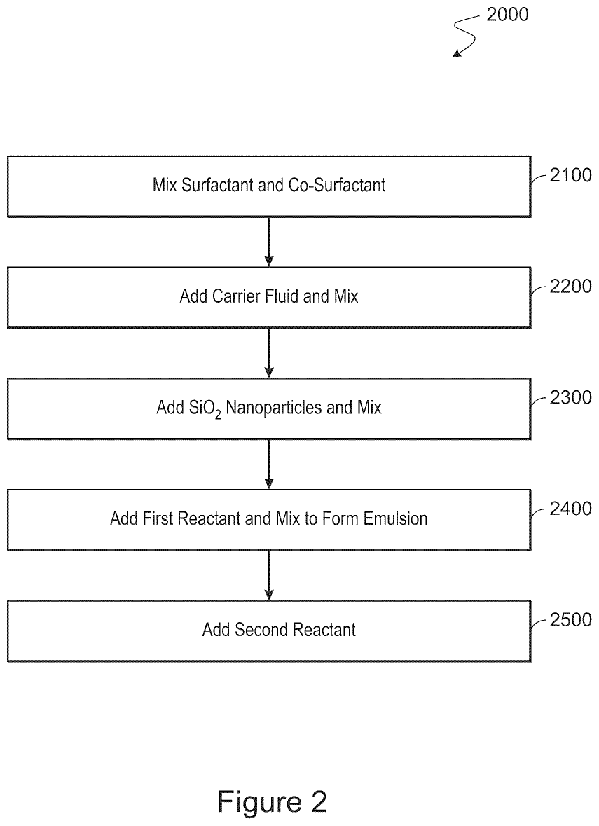

FIG. 2 is a flow diagram for an embodiment of a method 2000 of making an emulsion surrounding a thermochemical reactant. In step 2100, a surfactant and a co-surfactant are mixed. In step 2200, a carrier fluid is added, followed by mixing. In step 2300, SiO₂ nanoparticles are added, followed by mixing. In step 2400, a first reactant of the thermochemical fluid is added, followed by mixing to form an emulsion surrounding the first reactant, with the emulsion containing the surfactant and the silica nanoparticles. In step 2500, the second reactant of the thermochemical fluid is added. The result is the composition 1000 shown in FIG. 1a.

In general, the amount of each constituent (first reactant, second reactant, surfactant, co-surfactant, SiO₂ nanoparticles, carrier fluid) is selected so that the amount of each constituent in the composition 1000 is as disclosed above.

Generally, the mixing times of the various steps are independently selected as appropriate. In certain embodiments, each mixing time can independently be selected to be at least 1 (e.g. at least 2, at least 3, at least 4, at least 5, at least 10, at least 15, at least 30, at least 60, at least 90) minutes and at most 150 (e.g. at most 150, at most 120, at most 90, at most 60, at most 30, at most 15, at most 10, at most 5) minutes.

In general, the mixing speeds of the various steps are independently selected as appropriate. In certain embodiments, each mixing speed can independently be selected to be at least 250 (e.g., at least 500, at least 750, at least 1000) revolutions per minute (rpm) and at most 2000 (e.g., at most 1500, at most 1250, at most 1000) rpm.

### EXAMPLES

### Example 1: Preparation of Thermochemical Reactant-Diesel Emulsion

Using a hot plate and a magnetic stirrer, 1.6 centimeters cubed (cm³) polyvinyl alcohol (Kuraray Co., Ltd) and 0.4 cm³ ethanol were combined and mixed at 1000 rpm for 5 minutes. 12 cm³ diesel was added and the solution was mixed at 1000 rpm for a further 5 minutes. Solid particles of SiO₂ (Aldrich) were added and mixed at 1000 rpm for 10 minutes. The concentration of SiO2 in the formulation was varied as 0.5%, 1%, and 2% wt./v. in the final solution (corresponding to 0.1, 0.2 and 0.4 g, respectively in 20 cm³ total volume). Subsequently, 6 cm³ of 3 molar (M) NH₄Cl (reactant A) was added and the solution was mixed at 1000 rpm for 30, 60, 90, 120, or 150 minutes.

The solution contained 30% v/v thermochemical fluid (TCF) (NH₄Cl: reactant A) as the dispersed phase and 70% v/v continuous phase which consists of 60% v/v diesel oil, 8% v/v PVA and 2% v/v ethanol. To the solution, 6 cm³ of 3 M NaNO₂ (reactant B) was added.

### Example 2: Stability and Particle Size Measurement

Phase separation was observed in the real time with the aid of a light source and video camera. In addition, the particle sizes of emulsions were analyzed using an optical/video microscopy method with the aid of a light microscope (Penta View Model 44348). The light microscope had a 40/0.65 objective lens and was interfaced with a computer. A SONY (DSC-HX100V 16.2MP) compact camera was used for image acquisition. For each test, a drop from the emulsion sample was carefully placed on a microscope slide (76 mm×26 mm, 0.3 mm-1.0 mm; Matsunami Glass). Then, a cover slip (22 mm×22 mm, 0.12 mm-0.17 mm thick; Matsunami Glass) was placed over it immediately. Video and still images of the emulsion particles were recorded. The particle sizes were determined using ImageJ. The data obtained after analysis from the ImageJ were then fit with Equations 1 and 2 using MATLAB.

The average diameter of particles was estimated using volume mean diameter (dᵥ) giving in Equation (1), while the size distribution was expressed by the probability density distribution function (PDF)-Lognormal distribution function (Equation 2):

$${d}_{v} = \frac{\sum ( {nidi}^{4} )}{\sum ( {nidi}^{3} )} \qquad ( 1 )$$

$$f ( x ) = \frac{1}{x σ \sqrt{2 π}} {e}^{-} \frac{{( ln ( x ) - ω )}^{2}}{2 {σ}^{2}} \qquad ( 2 )$$

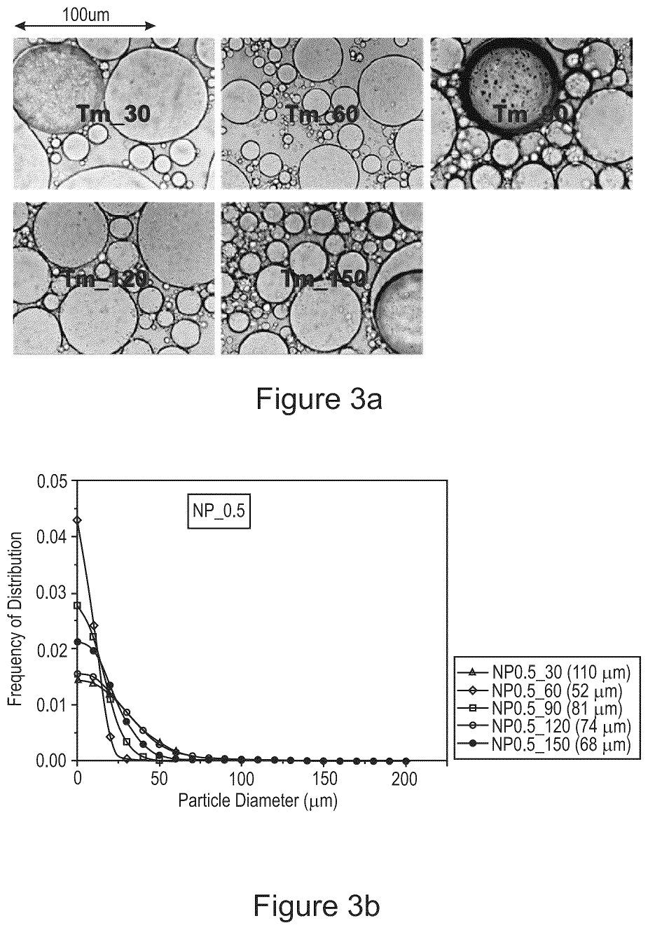

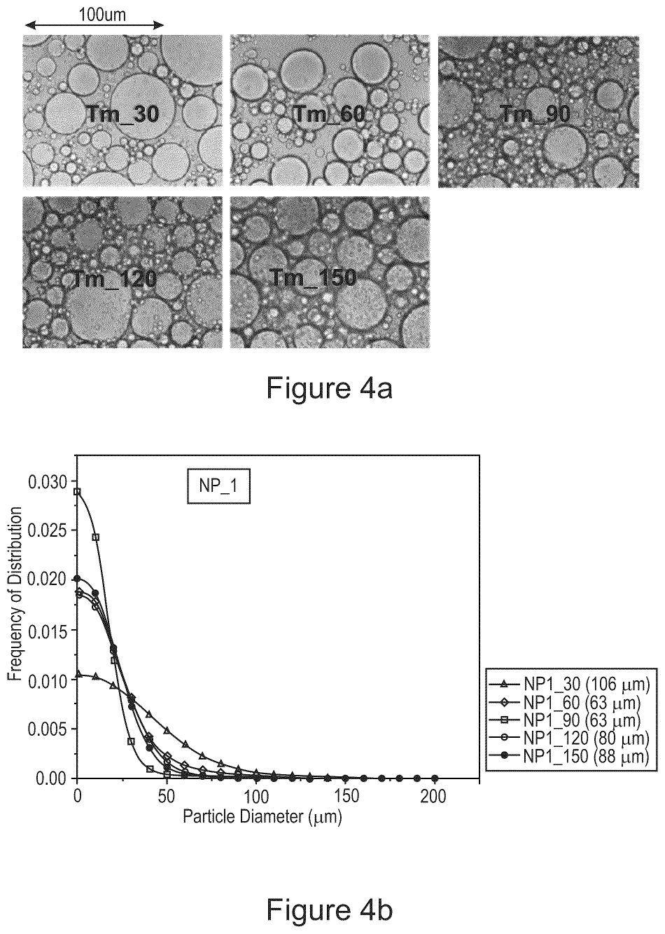

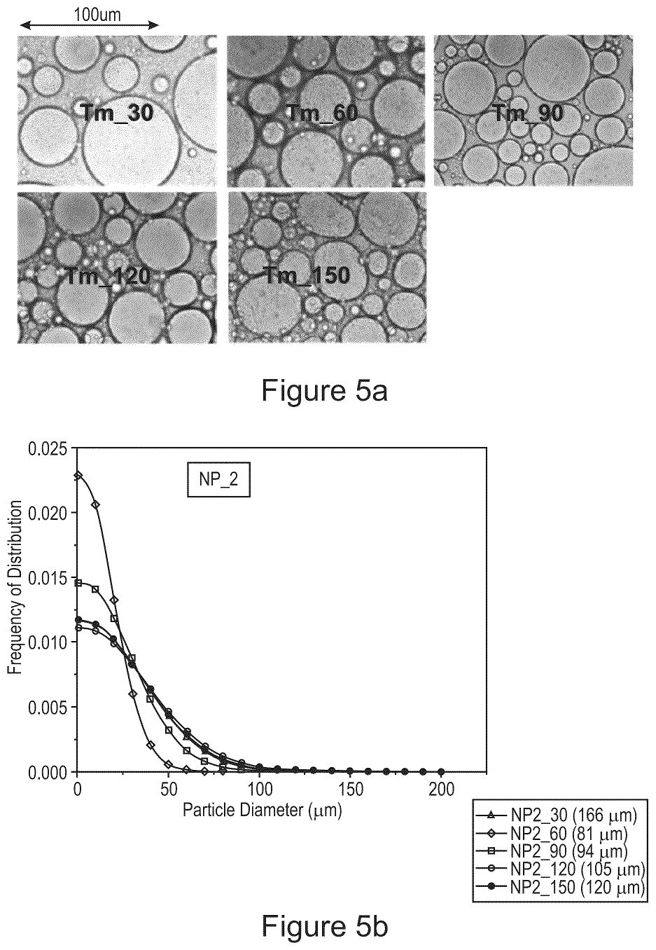

The particle size and distribution of the thermochemical reactant-diesel emulsion prepared with different concentrations of SiO₂ are presented in FIGS. 3a-5b. FIG. 3a presents photographic images and FIG. 3b presents the particle size distribution of emulsions containing 0.5% wt./v. SiO₂ at mixing times of 30, 60, 90, 120 and 150 minutes. FIG. 4a presents photographic images and FIG. 4b presents the particle size distribution of emulsions containing 1% wt./v. SiO₂ at mixing times of 30, 60, 90, 120 and 150 minutes. FIG. 5a presents photographic images and FIG. 5b presents the particle size distribution of emulsions containing 2% wt./v. SiO₂ at mixing times of 30, 60, 90, 120 and 150 minutes.

Generally, the particle sizes are polydispersed towards smaller particles in the mixture. Further, the range of particle size from each mixture appeared to increase with increasing concentration of SiO₂. For emulsion containing 0.5% wt./v. SiO₂, the particle diameter ranged between 22-36 micrometers (μm). For emulsions containing 1% wt./v. SiO₂ the particle diameter ranged between 26-44 μm. For emulsion containing 2% wt./v. SiO₂, the particle diameter ranged between 38-55 μm. FIGS. 3b, 4b and 5b show that the particle diameters initially decreased as the mixing time increased from 30 to 60 minutes. As the mixing time increased from 60 to 90 minutes, the particle diameter increased for emulsions containing 0.5% or 2% wt./v. SiO₂, whereas the particle diameter decreased for emulsions containing 1% wt./v. SiO₂. Increasing the mixing time from 90 to 150 minutes, did not cause a further decrease in the particle size.

The optimal mixing time at 1000 rpm was determined to be 90 minutes as it generally gave a medium sized emulsion relative to other mixing times. Without wishing to be bound by theory, it is believed that lower emulsion sizes may form very tight emulsions relative to larger emulsion sizes while larger emulsions might cause phase inversion or have lower stability relative to smaller emulsion sizes.

### Example 3: Controlled Release Measurement of Thermochemical Reaction

Stability under gravitational settling was conducted using the bottle test. The bottle test was carried out by observing phase separation of emulsions during settling. About 8 ml of a freshly prepared emulsion solution was transferred into a graduated 10 mL Pyrex glass test tube, and immediately covered to avoid evaporation. Phase separation was observed in real time by visual observation with the aid of a monochromatic light source (LA-150TX, Hayashi).The concentration of NH₄Cl released from the emulsions (i.e. diesel oil) was quantified as equivalent of the percentage stability of emulsion observed in the real time. The stability (Sₑ) was calculated by finding the percentage of original aqueous phase separated from the emulsion. The total aqueous phase constituted 40 v/v % of the mixture, while the fraction corresponding to the thermochemical reactant was 75 v/v % of the aqueous phase (i.e. Concentration of thermochemical reactant (Cₜ)=0.75×Sₑ). Thus, the concentration of thermochemical reactant released can be calculated using equations 3 and 4 as follows:

$${S}_{e} = ( \frac{{V}_{t}}{{V}_{o}} ) * 100 \qquad ( 3 )$$

$${C}_{t} = 0.75 * {S}_{e} \qquad ( 4 )$$

where Sₑ is the percentage stability of emulsion, Vₜ and Vₒ are the volume of aqueous phase separated at any time (t) and the original total volume of the aqueous phase present. Cₜ is the concentration of thermochemical reactant released at any time (t).

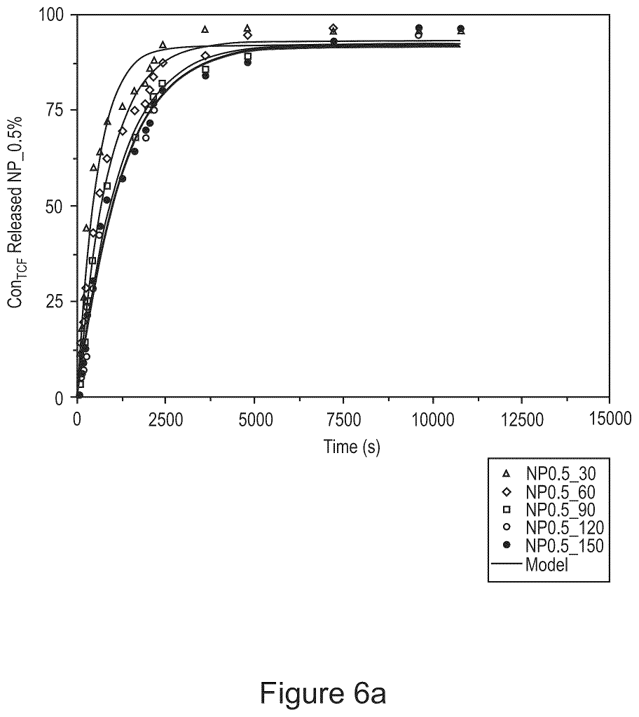

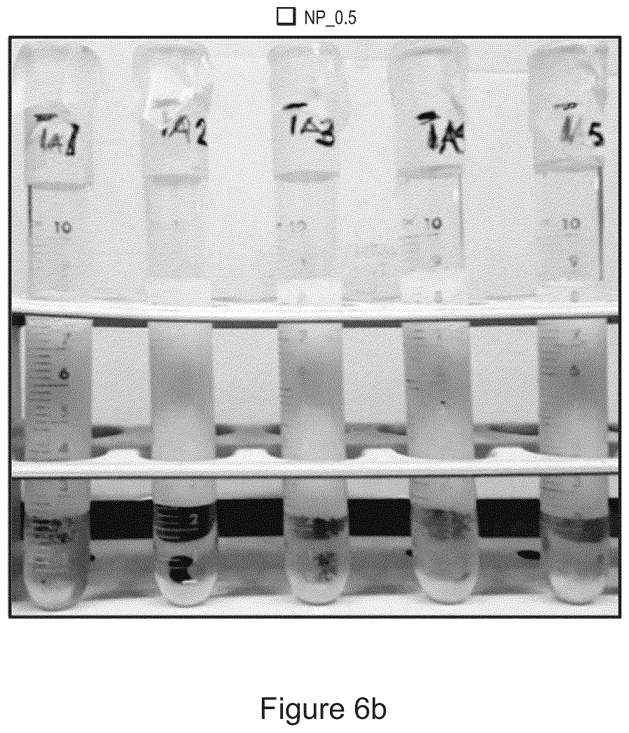

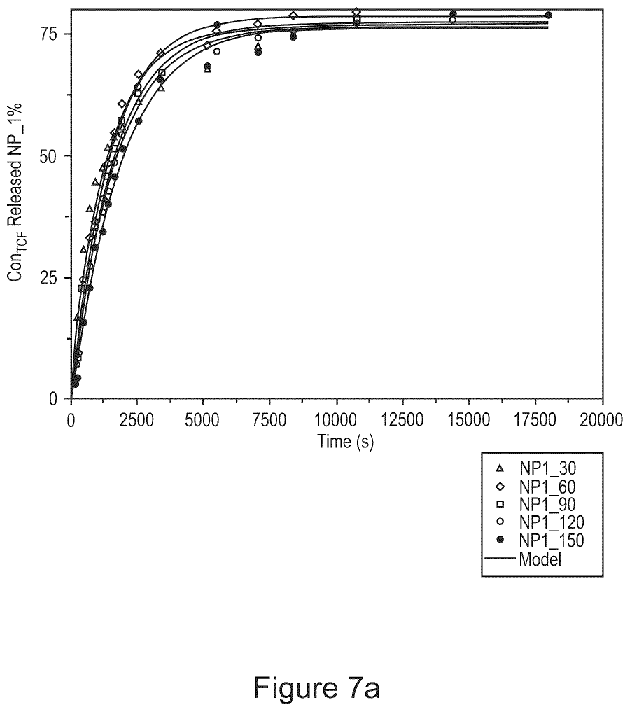

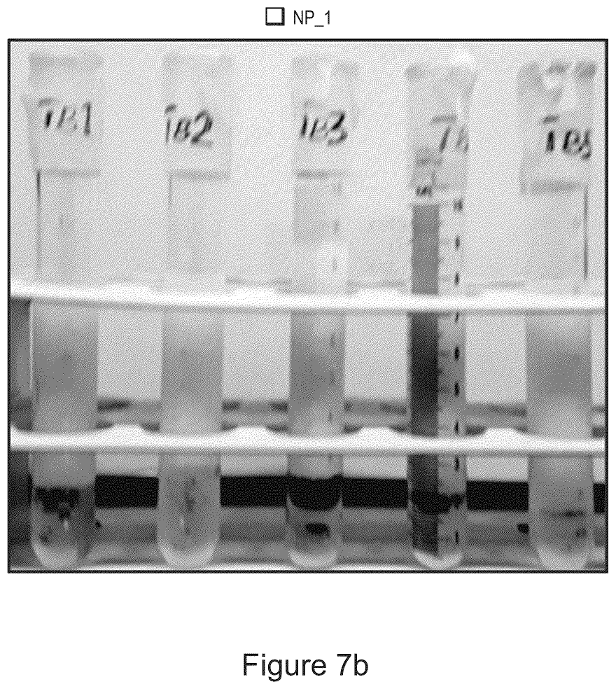

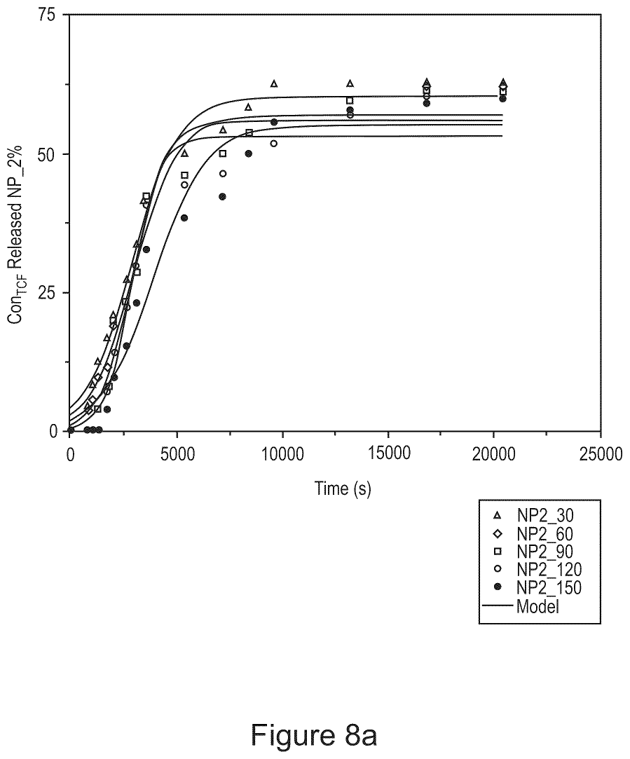

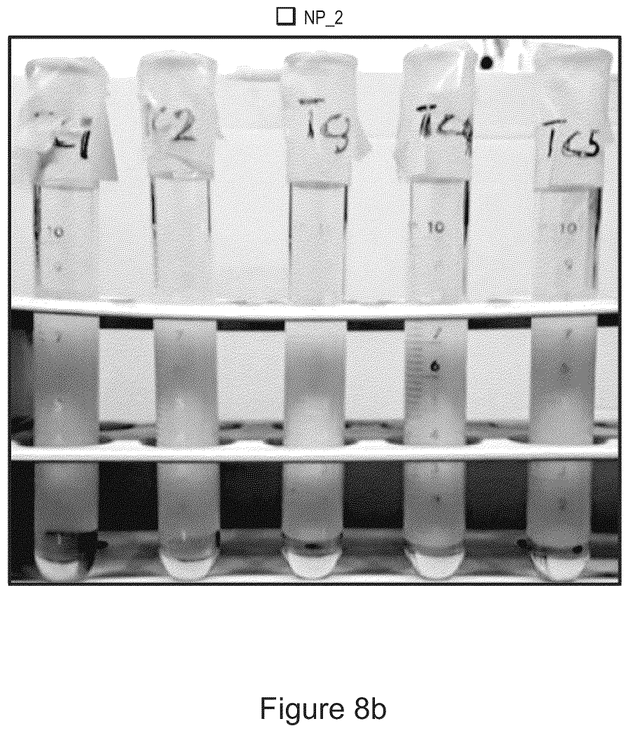

FIGS. 6a, 7a, and 8a show the change in thermochemical fluid (TCF, i.e. thermochemical reactant, NH₄Cl) concentration released with time from NH₄Cl-diesel emulsions stabilized with 0.5, 1, and 2% wt./v. of SiO₂, respectively. From FIG. 6a, it can be observed that more than 90% of the NH₄Cl had been released from the emulsion phase in about 40 minutes. In addition, there was no significant difference observed between the concentrations released due to different mixing times. FIG. 6b shows a picture taken of the emulsions after 5 hours of observation, with mixing times of 30, 60, 90, 120 and 150 minutes shown from left to right. The picture shows a diesel layer (top) which contained some residual aqueous phase stabilized by the SiO₂ nanoparticles and an aqueous phase (bottom) which contained the reactant. The height or volume of TCF (NH₄Cl) reactant released (aqueous phase separated) from the emulsions were nearly identical for all mixing times. Similarly, FIG. 7a shows that a lower quantity of the NH₄Cl was released from the emulsion phase compared to FIG. 6a, with about 80% released after 85 minutes. FIG. 7b is a picture of the samples taken after 6 hours of observation, with mixing times of 30, 60, 90, 120 and 150 minutes shown from left to right. From FIG. 8a, a significant delay in the quantity of NH₄Cl released from the diesel phase can be observed. Furthermore, FIG. 8a shows that the mixing time affected the amount released. In addition, on average, about 60% of reactant A was observed to be released after 90 minutes and this percentage was maintained for 6 hours of observation. As seen in FIG. 8b, with mixing times of 30, 60, 90, 120 and 150 minutes shown from left to right, the samples demonstrated significant stability for more than 48 hours of storage. Compared to FIGS. 6b and 7b, FIG. 8b shows that the amount of TCF released was significant smaller during storage, indicating a higher stability.

The differential release rate of the TCF NH₄Cl

$$( \frac{{dC}_{TCF}}{dt} )$$

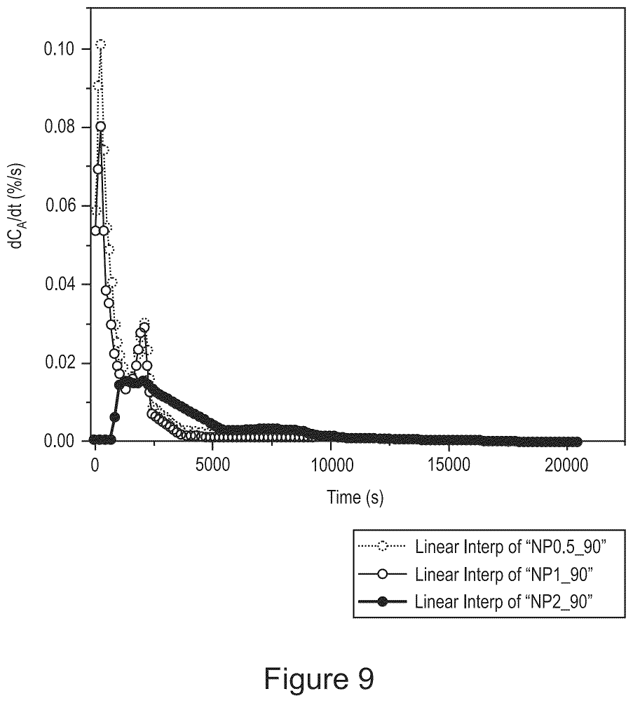

at different concentrations of SiO₂, was calculated at a mixing time of 90 minutes and is shown in FIG. 9. The curves in FIG. 9 quantitatively compare the effect of SiO₂ on the TCF release rate and demonstrate that the release rate of TCF can be significantly delayed using 2% SiO₂. Specifically, it was be observed that the highest release rate of 0.1% TCF/s was released from the mixture containing 0.5% SiO₂, followed by a release rate of 0.08% TCF/s from the mixture containing 1% SiO₂, within the first 15 minutes. In comparison, lowest rate of 0.02% TCF/s was observed for the mixture containing 2% of SiO₂, within the first 15 minutes. This value remained constant until after 40 minutes. After 1 hour, a rate as high as 0.01% TCF/s was observed from the mixture containing 2% SiO₂, while those containing 0.5 and 1% SiO₂ had decreased significantly to less than 0.001% TCF/s. The TCF release rate was sustained over a longer period of time (greater than 6 hours) from the emulsions containing 2% SiO₂ compared with the other samples.

### Example 4: Controlled Reaction of Thermochemical Reactants

In a batch operation, the thermochemical reaction normally reaches conversion equilibrium in a short time which ranges between 5 and 1500 s (as shown in FIGS. 1a, 1b and 2), depending on the temperature of reaction, pH, and molarity of the reactants.

The reaction between NH₄Cl-in-diesel emulsions (diesel+Reactant A) and NaNO₂ (Reactant B) was carried out in a 100 ml Pyrex cylindrical glass reactor with a 20 ml total reaction mixture volume (6 ml of 3 M NaNO₂ and 6 ml of 3 M NH₄Cl surrounded by emulsions with 0.5, 1 or 2% wt./v. SiO₂ in the diesel phase and a mixing time of 90 minutes). The reference reaction was conducted using the same volume of NH₄Cl and NaNO₂ in the absence of diesel and emulsions. The kinetics of the reactions were monitored by recording temperature at equal time intervals of 250 seconds using a temperature data logger interfaced with a computer. The reaction had the stoichiometry:

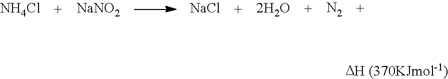

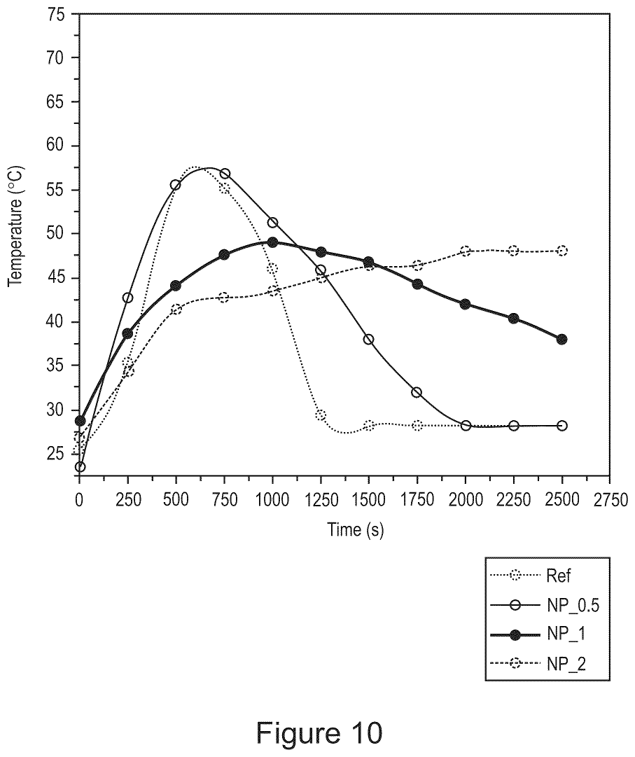

The temperature change with time due to heat generated from the thermochemical reaction between the thermochemical reactants NH₄Cl and NaNO₂ was measured for emulsified thermochemical reactants with 0.5, 1 and 2% wt./v. SiO₂ as well as a reference sample that contained the thermochemical reactants without emulsions. The pH of the mixtures both with and without emulsions remained constant (pH=4.38). FIG. 10 shows that as concentration of the SiO₂ increases, the temperature change was delayed longer. The reference reaction without emulsions reached a peak temperature of 58° C. in about 8 minutes, while the same peak temperature was reached at 10 minutes for the samples containing emulsions with 0.5% wt./v. SiO₂. The temperature change was delayed by 20 minutes with a temperature of 48-36° C. for samples containing emulsions with 1 and wt./v. SiO₂ and for more than 45 minutes with a temperature of 40-48° C. for samples containing emulsions with 2% wt./v. SiO₂.

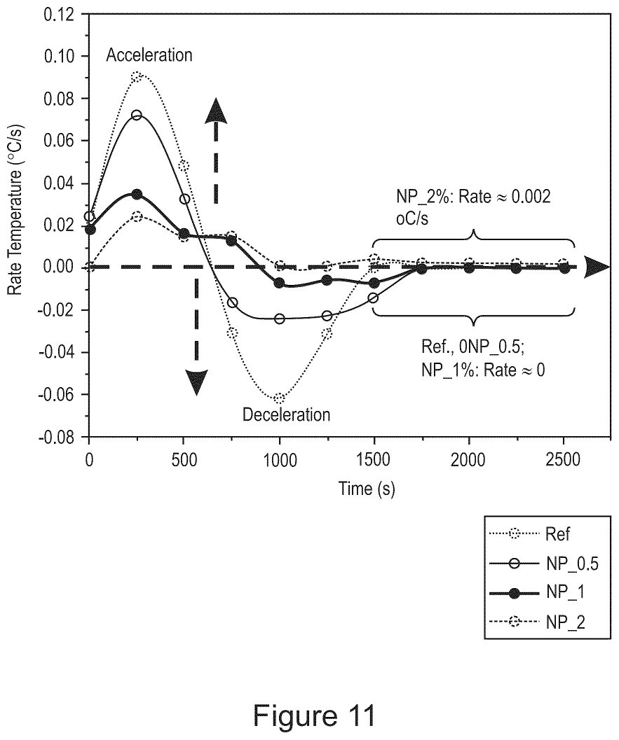

FIG. 11 presents quantitative analysis of the system in terms of the differential rate of temperature change

$$( \frac{dT}{dt} ° C . \text{/s} ) .$$

Initially, all of the reactions, including the reference sample without emulsions, showed accelerated temperature rate at the initial period (0-500 s). The highest rates observed for the reference reaction as well and the sample with 0.5% SiO₂ were 0.09 and 0.07° C./s, respectively, which occurred between 0-500 s reaction time. Without wishing to be bound by theory, it is believed that the accelerated temperature rate at the beginning of the reaction may be due to high collision rate and/or reactivity. Beyond this period, the reactions showed rate deceleration, with the larges changes observed in the reference case and the sample with 0.5% SiO₂. However, the curves showed that the temperature release rates were significantly delayed for samples with 1 and 2% SiO₂.

FIG. 11 shows that the temperature release rate were maintained at lower rates but over a long period of time (more than 6 hrs.) for samples with 2% SiO₂.

### Example 5: Foam Stability

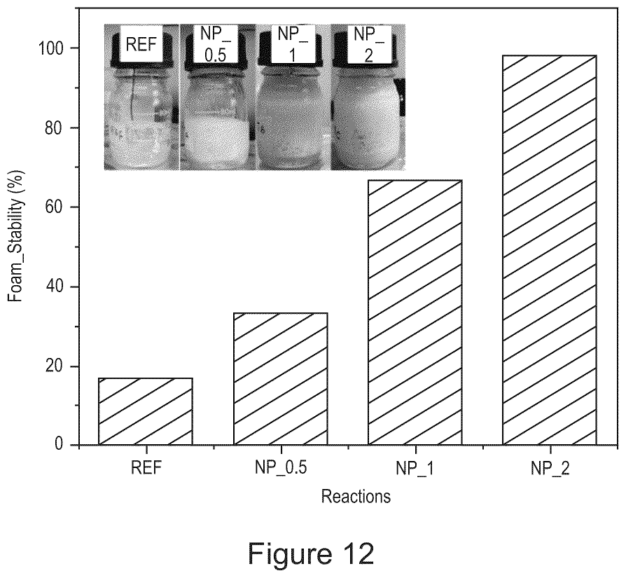

The foam stability was measured using the bottle test in a graduated 100 mL Pyrex glass bottle with a cover by visual observation of height difference of foamy layer of the system. The foam stability was calculated as:

$${F}_{e} = ( \frac{{H}_{t}}{{H}_{o}} ) * 100 \qquad ( 5 )$$

where Fₑ is the percentage foam stability after 30 minutes, Hₜ and Hₒ are the height of foamy layer after 30 minutes and the height after 5 minutes into the reaction, respectively. FIG. 12 shows the foam stability due to generation of N₂ gas. The foam stability increased as the concentration of SiO₂ increased. Samples with 0.5, 1, and 2% wt./v. SiO₂ had foam stabilities of 30, 70, and 90% respectively, compared with a foam stability of 18% for the reference reaction.

1.-15. (canceled)

16. A method, comprising:
providing a composition, comprising:
a first reactant;
an emulsion surrounding the first reactant, the emulsion comprising a surfactant and silicon dioxide (SiO₂) nanoparticles; and
a carrier fluid comprising a second reactant, the carrier fluid comprising the second reactant surrounding the emulsion; and
allowing a portion of the first reactant to diffuse through the emulsion so that the first and second reactants react to generate heat.

17. The method of claim 16, wherein the reaction of the first and second reactants generates a gas.

18. The method of claim 16, wherein:
the first reactant comprises an ammonium ion and the second reactant comprises a nitrite ion; and
the second reactant comprises an ammonium ion and the first reactant comprises a nitrite ion.

19. The method of claim 16, wherein at least 60% of the first reactant diffuses through the emulsion within 90 minutes.

20. A method of forming an emulsified thermochemical reactant comprising, the method comprising:
a. mixing a surfactant and a co-surfactant to form a first composition;
b. adding a carrier fluid to the first composition and mixing to form a second composition;
c. adding silicon dixoide (SiO₂) nanoparticles to the second composition and mixing to form a third composition;
d. adding a first reactant to the third composition and mixing to form an emulsion surrounding the first reactant, the emulsion comprising the surfactant and the silica nanoparticles; and
e. after d) adding a second reactant so that the second reactant surrounds the emulsion,
wherein, when the first and second reactants react, they generate heat.

21. The method of claim 16, wherein the first reactant comprises an ammonium ion and the second reactant comprises a nitrite ion.

22. The method of claim 21, wherein the reaction of the first and second reactants generates a gas.

23. The method of claim 22, wherein at least 60% of the first reactant diffuses through the emulsion within 90 minutes.

24. The method of claim 16, wherein the second reactant comprises an ammonium ion and the first reactant comprises a nitrite ion.

25. The method of claim 24, wherein the reaction of the first and second reactants generates a gas.

26. The method of claim 25, wherein at least 60% of the first reactant diffuses through the emulsion within 90 minutes.

27. The method of claim 18, wherein the reaction of the first and second reactants generates a gas.

28. The method of claim 27, wherein the gas comprises nitrogen (N₂).

29. The method of claim 28, wherein the composition is configured so that the gas has a foam stability of at least 25%.

30. The method of claim 17, wherein the gas comprises nitrogen (N₂).

31. The method of claim 30, wherein the composition is configured so that the gas has a foam stability of at least 25%.

32. The method of claim 16, wherein one of the following holds:
the first reactant comprises a member selected from the group consisting of ammonium chloride, ammonium bromide, ammonium nitrate, ammonium sulfate, ammonium carbonate, and ammonium hydroxide, and the second reactant comprises a member selected from the group consisting of sodium nitrite and potassium nitrite; and
the second reactant comprises a member selected from the group consisting of ammonium chloride, ammonium bromide, ammonium nitrate, ammonium sulfate, ammonium carbonate, and ammonium hydroxide, and the first reactant comprises a member is selected from the group consisting of sodium nitrite and potassium nitrite.

33. The method of claim 16, wherein the surfactant comprises polyvinyl alcohol.

34. The method of claim 16, wherein the composition comprises between 0.5 percent weight/volume (% wt./v.) and 2% wt./v. of SiO₂ nanoparticles.

35. The method of claim 16, wherein the emulsion has a diameter of from 50 micrometers to 200 micrometers.
